(19) United States
(12) Patent Application Publication
(10) Pub. No.: US 2006/0139237 A1
(43) Pub. Date: Jun. 29, 2006

(54) Driver circuit, in particular for laser diodes, and method for providing a drive pulse sequence

(75) Inventors: Herbert Knotz, Erbach (DE); Armin Prohaska, Ulm (DE); Stefan Schabel, Syrgenstein (DE)

Correspondence Address: MCGRATH, GEISSLER, OLDS & RICHARDSON, PLLC, P.O. BOX 1364, FAIRFAX, VA, 22038-1364, US

(73) Assignee: ATMEL GERMANY GMBH, Heilbronn (DE)

(21) Appl. No.: 11/315,253

(22) Filed: Dec. 23, 2005

(30) Foreign Application Priority Data
Dec. 23, 2004 (DE) DE102004063198.0

(51) Int. Cl. G09G 3/06

(52) U.S. Cl. 345/44

(57) ABSTRACT

A driver circuit that provides a driver pulse sequence with different adjustable driver pulse heights in different time segments is provided. The driver circuit includes n pulse generators that supply pulse height contributions to a summing node, wherein the supplying can be controlled by switching elements individual to the pulse generators, and further includes a control unit that controls at least some of the switching elements as a function of adjustable parameters. The driver circuit also includes a switching matrix with matrix elements, each one of which is associated with a pair having at least one of the time segments and at least one control parameter, and issues a control signal for exactly one switching element of one of the n pulse generators.

This nonprovisional application claims priority under 35 U.S.C. § 119(a) on German Patent Application No. 10 2004 063 198.0, which was filed in Germany on Dec. 23, 2004, and which is herein incorporated by reference.

### BACKGROUND OF THE INVENTION

1. Field of the Invention

The invention relates to a driver circuit, which provides a driver pulse sequence with different adjustable driver pulse heights in different time segments, having n pulse generators which supply pulse height contributions to a summing node, wherein the supplying can be controlled by switching elements individual to the pulse generators, and having a control unit that controls at least some of the switching elements as a function of adjustable parameters.

The invention further relates to a method for providing a driver pulse sequence.

2. Description of the Background Art

Conventional driver circuits for laser diodes in DVD and/or CD units are known. In the conventional driver circuit, outputs of, for example, five digital-to-analog converters (DAC) are wired to a summing node. The sum of the effective contributions of the five DACs at the summing node determines the resulting driver pulse height. The contribution of each DAC is set by an individual data value. Enable signals control switches between the DACs and the summing node. In different time segments of the driver pulse sequence, different enable signals are issued so that different driver pulse heights can be set in the individual segments.

The resultant driver pulse sequence is also called a write strategy. In the prior art driver circuit and the corresponding prior art method, a write strategy is thus specified by defining the five driver pulse heights, which is to say through specific data values for the contributions of each individual DAC and specific combinations of the DAC contributions in each segment of the driver pulse sequence. In this context, the combinations are produced by certain combinations of digital mode parameters, which determine which enable signals are equal for a certain pulse type. Consequently, equal enable signals have the result that multiple DACs provide contributions to the summing node for the specific pulse type. In this context, the mode parameters specify which enable signals are issued in a certain segment. Five different driver pulse heights are defined by means of five digital mode parameters. Each of the five driver pulse heights corresponds to a partial sum of the contributions of the five DACs. By combinations of enable signals, which actuate the switches in the connection of each DAC to the summing node, each partial sum can be connected to the summing node. A read pulse segment can be defined as the contribution of a single, specific DAC, for example, while a write pulse segment, which demands a higher optical power from the laser diode, is formed as the sum of the contributions of all five DACs, for example. Thus, in the prior art driver circuit the mode parameters define which DACs provide contributions to one of the five defined driver pulse heights.

In addition, the conventional driver circuit has a differential input IN/NIN, through which a series of the individual segments of a driver pulse sequence are fed in encoded form into the driver chip. A pulse decoder decodes the encoded form, and from this generates the enable signals while taking into account the mode parameters; the contributions of the DACs to the resulting driver pulse height at the summing node are directly controlled by these enable signals.

The five defined driver pulse heights cannot be changed within a write strategy. Therefore, in particular the heights of two pulses of one pulse type within a write strategy are always equal. Further restrictions result from the necessary decoding; even though 32 different combinations are theoretically possible with five digital mode parameters, the pulse decoder cannot generate useful DAC enable signal combinations with most of the theoretically possible combinations. Therefore, only eight useful and decodable mode parameter combinations, and thus eight write strategies, are available. Additional write strategies can only be set in this prior art by complex changes to the driver circuit.

### SUMMARY OF THE INVENTION

It is therefore an object of the present invention to provide a driver circuit and also to provide a method for more flexible generation of driver pulse sequences.

This object is attained in a driver circuit having a switching matrix with matrix elements, each one of which is associated with a pair including at least one of the segments and at least one control parameter, and issues a control signal for exactly one switching element of one of the n pulse generators. In addition, this object is attained in a method through the use of such a driver circuit.

In contrast to the conventional art, the pulse decoder thus no longer controls the contributions of the pulse generators directly, but instead addresses the switching matrix, each of whose matrix elements is associated with one segment of the driver pulse sequence and one of the pulse generators. Thus, there are as many matrix elements for each segment of the driver pulse sequence as there are pulse generators. With the control signal, each matrix element contains the information as to whether the associated pulse generator should provide a contribution in this segment. Each matrix element can thus be associated with at least one individual control parameter. In contrast to the conventional art, the system is no longer limited to eight mode parameter combinations, which correspond to specified write combinations. Rather, by changing the control parameters, each matrix element can be changed independently of the other matrix elements, permitting more flexible generation of a variety of different drive pulse sequences. In this way, the invention permits, in particular, a significantly more flexible generation of write strategies.

With respect to embodiments of the driver circuit, it is preferred for the driver circuit to have an allocation table in which the control parameters of the switching matrix are stored.

In consequence, the behavior of the switching matrix can be determined in a simple manner by writing values into the allocation table.

Further, at least some of the control parameters can be variable.

This embodiment permits simple alteration of the behavior of the switching matrix and thereby, for example, permits simple, flexible and thus application-specific generation of write strategies for laser diode drivers. Moreover, this embodiment makes it possible to distinguish between variable control parameters and non-variable control parameters. The non-variable control parameters thus need not be changed with every change in the write strategy, reducing the effort involved in making changes.

The switching matrix can have, for each matrix element, at least one AND gate that has a first input, a second input, and an output that is connected to the associated switching element.

This embodiment represents a simple circuit implementation of a switching matrix with the properties described further above.

The first input of the AND gate can be supplied with a signal characterizing the associated segment, and for the second input of the AND gate to be supplied with the variable control parameter.

This embodiment allocates a pulse generator to each pair having a control parameter and a signal that characterizes a segment. In this way, competing signal influences on the pulse generator are avoided.

Another embodiment can include OR gates whose inputs are connected to outputs of at least two AND gates.

This embodiment allows defined control of each pulse generator even in segments that overlap. In this regard, the pulse generator always supplies a contribution when one of the two AND gates outputs a logic one. Overlapping segments occur, for example, during the driving of laser diodes, where, for example, a mono pulse segment can extend across a sequence of a first pulse segment, multi pulse segment, and last pulse segment. When the mono pulse control parameter is set, it then makes no difference whether first pulse and/or multi pulse and/or last pulse control parameters are set.

In another embodiment, even for matrix elements to which no variable control parameters are allocated, the switching matrix can have, for each matrix element, an AND gate with a first input, a second input, and an output, wherein the first input is supplied with a signal characterizing the allocated segment, the second input is supplied with a fixed value as control parameter, and the output is connected to the associated switching element.

By such a symmetrical structure, the behavior of the switching matrix is further optimized, since the same number of AND gates is connected to the inputs and outputs of the switching matrix in each case. Undesirable errors in the input/output behavior of the switching matrix, which could result, for example, from one input being driven by a first number of AND gates while another output drives a second number of AND gates, are prevented in this way.

Also, the AND gates and the OR gates can each have equal rise and fall times.

In this way, differences in propagation delay in the driver circuit are avoided. It may be sufficient in this regard for the OR gates to have equal response times among themselves and for the AND gates to have response times that are equal among themselves but may differ from the response times of the OR gates.

Another embodiment provides digital-to-analog converters (DACs) as pulse generators.

Such DACs are available as standard components, thus allowing for the pulse generators to be implemented in an economical way.

With respect to embodiments of the method, the chronologically sequential segments of variable driver pulse height can have at least one space segment and/or one first pulse segment and/or one last pulse segment and/or one multi pulse segment and/or one mono pulse segment and/or one cool pulse segment.

Driver pulse sequences containing such segments are used for controlling laser diodes in optical write and read devices. All of the aforementioned advantages are exhibited in this environment. This embodiment therefore conveys the aforementioned advantages in this preferred area of application.

At least one of the control parameters can act as a pulse generator disable signal and other control parameters can act as pulse generator enable signals.

As a result, the effort for generating a write strategy resulting from the definition of the mode parameters is further reduced, for example when small contributions of a pulse generator arise in the composition of most partial sums. It is then less complicated to only need to set these parameters when the associated contribution should not be represented in a segment.

In another embodiment, a mono pulse enable signal can have precedence over a first pulse enable signal and a multi pulse enable signal.

This embodiment avoids competing enable signals in the cases when a mono pulse explicitly should be set.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates an example embodiment of a driver circuit according to an embodiment of the present invention;

FIG. 2 illustrates an example embodiment of a technical implementation of a switching matrix and allocation table in a driver circuit;

FIG. 3 show time segments of a driver pulse sequence in a decoded form;

FIG. 4 is an allocation table filled with concrete values; and

FIG. 5 is a driver pulse sequence with multi pulse segments resulting from the interaction of the subjects of FIGS. 3 and 4.

### DETAILED DESCRIPTION

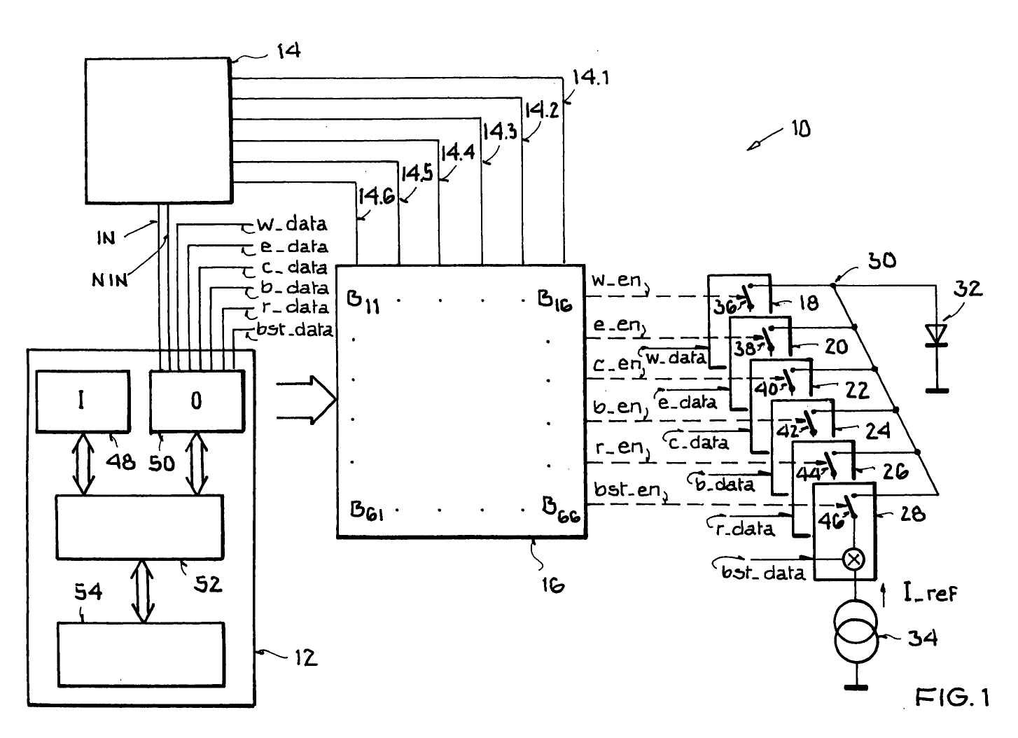

FIG. 1 shows a driver circuit 10 with a control unit 12, a pulse decoder 14, a switching matrix 16, and an arrangement of pulse generators 18, 20, 22, 24, 26, 28, which supply pulse contributions to a summing node 30. A component 32 which is to be driven, for example a laser diode, is connected to the summing node.

Each pulse generator 18, 20, 22, 24, 26, 28 is implemented as, for example, a digital-to-analog converter (DAC), which is supplied with a reference current I_ref by a reference current source 34 and which provides this reference current I_ref, in a form weighted according to a digital data value that is also received, to a switching element 36, 38, 40, 42, 44, 46. When the switching element 36, 38, 40, 42, 44, 46 is closed, the associated pulse generator 18, 20, 22, 24, 26, 28 supplies its current weighted by an individual data value w_data, e_data, c_data, b_data, r_data, bst_data as an output current to the summing node 30. The abbreviations w, e, c, b, r, bst stand for write, erase, cool, bottom, read and boost in a laser diode driver, for example. A current amplitude resulting from the output currents at the summing node 30 is thus determined by a choice of pulse generators 18, 20, 22, 24, 26, 28 to be activated by corresponding enable signals and also by the associated data values with which the magnitude of the contributions of the selected pulse generators 18, 20, 22, 24, 26, 28 can be set.

In the embodiment shown, a first pulse generator 18 is activated by a write-enable signal (w_en), a second pulse generator 20 by an erase-enable signal (e_en), a third pulse generator 22 by a cool-enable signal (c_en), a fourth pulse generator 24 by a bottom-enable signal (b_en), a fifth pulse generator 26 by a read-enable signal (r_en), and a sixth pulse generator 28 by a boost-enable signal (bst_en), which in each case turns on an associated switching element 36, 38, 40, 42, 44, 46.

The control unit 12 is implemented, for example, as a computer that has an input interface 48 for processing input signals and an output stage 50 for outputting output signals. A microprocessor 52 controls the output stage 50 as a function of data and programs stored in a memory 54; these data and programs may be changed via the input interface 48, for example. The output stage 50 outputs the aforementioned data values, for example, in order to control the height of the contributions of the pulse generators 18, 20, 22, 24, 26, 28. In addition, the output stage 50 outputs a differential signal IN/NIN, which specifies, in encoded form, certain time segments of a driver pulse sequence to be set at the summing node 30. Furthermore, the output stage 50 may also be designed such that it controls the switching matrix 16. This is explained in detail further below.

The pulse decoder 14 decodes the differential signal IN/NIN and, through connections 14.1, 14.2, 14.3, 14.4, 14.5, 14.6, provides segment signals with which columns or rows of the switching matrix 16 are addressed. In the representation in FIG. 1, the pulse decoder 14 addresses columns of the switching matrix 16. The segment signals define individual time segments of the pulse sequence to be set at the summing node 30. When the driver circuit 10 is used to drive a laser diode, the time segments represent, for example, a space pulse segment and/or a first pulse segment and/or a multi pulse segment and/or a mono pulse segment and/or a last pulse segment. The time segments may also overlap.

In this case, each row of the switching matrix 16 controls one of the pulse generators 18, 20, 22, 24, 26, 28. To this end, the switching matrix 16 outputs for each of its matrix elements an enable signal Bᵢₖ as a control signal, which activates the pulse generator 18, 20, 22, 24, 26, 28 of the associated i-th row. To this end the enable signals Bᵢₖ of the matrix elements of each i-th row are connected together by OR gates. Because of the connection by OR gates, a possible overlap of the time segments is noncritical. In this case the activating signals always dominate. The control signals Bᵢₖ are generated through an AND operation of an associated control parameter with a segment signal that specifies an associated time segment. In other words, each matrix element is individually assigned a pair comprised of at least one of the time segments and at least one control parameter, and issues a control signal Bᵢₖ for exactly one switching element 36, 38, 40, 42, 44, 46 of one of the pulse generators 18, 20, 22, 24, 26, 28.

As a result, therefore, by defining the matrix elements it is possible to predetermine for each of the time segments allocated to one column whether zero, one, a desired selection, or all pulse generators 18, 20, 22, 24, 26, 28 will be activated.

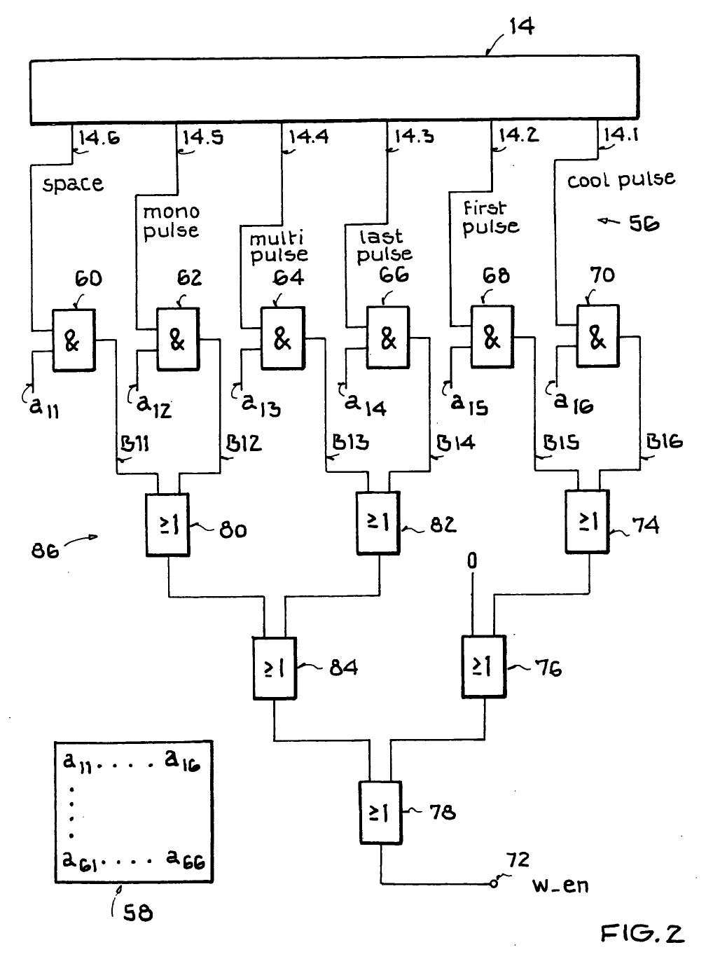

FIG. 2 shows a circuit design of a first row 56 of the switching matrix 16 together with an allocation table 58, which contains control parameters aᵢₖ for the matrix elements Bᵢₖ, and can be stored in the memory 54 of the control unit 12, for example. The first row 56 contains, first, a number of AND gates 60, 62, 64, 66, 68, 70 corresponding to the number of segments. Each of the AND gates 60, 62, 64, 66, 68, 70 is supplied with a signal that characterizes the associated segment. In addition, each AND gate 60, 62, 64, 66, 68, 70 is supplied with an associated control parameter aᵢₖ from the allocation table 58. The signal characterizing the segment has the value 1 during the time period of the segment, for example, and has the value 0 outside this period, for example.

If, for example, the associated control parameter a₁₁ has the value 0 during the space segment, the result for the control signal B₁₁ is likewise 0. Conversely, the value 1 results for B₁₁ if a₁₁ in the space segment is equal to 1. The same applies to the other control signals B₁₂, B₁₃, B₁₄, B₁₅, and B₁₆. In the following, it is assumed that the control parameter a₁₅ of the first pulse segment has the value 1, and that the first pulse segment signal is the only segment signal to have the value 1. The associated control signal B₁₅ is then likewise equal to 1, and OR gates 74, 76, 78 located between the AND gate 68 and an output 72 supply a 1 to the output 72. In this way, the enable signal w_en is output, which activates the pulse generator 18. The pulse generator 18 can also be activated in any other segment by the other AND gates 60, 62, 64, 66, 70 and OR gates 80, 82, 84.

In order to obtain equal signal propagation delays in the different signal paths leading to the output 72, the OR gates 74, 76, 78, 80, 82, 84 are preferably arranged in the tree structure 86 shown. The OR gate 76 is not required for the connection per se, but ensures that the sums of the rise times and fall times of the logic gates of the paths leading from the AND gates 60, 62, 64, 66, 68, 70 to the output 72 are equal from path to path. For the same reason, only gates having equal rise times and fall times are preferentially used.

The remaining rows of the switching matrix 16 may be structured in the same way. The rows then differ only in that they are connected to different pulse generators 18, 20, 22, 24, 26, 28, and accordingly supply there an e_en, c_en, b_en, r_en, or bst_en signal to the associated switching element 38, 40, 42, 44, or 46. In particular, each row has a series of AND gates, which likewise are connected to the connections 14.1 through 14.6 and to a row of the allocation table 58. By the additional rows, in the first pulse segment discussed above, for example, additional enable signals can be generated, which activate different pulse generators 20, 22, 24, 26, 28 alternatively to or in addition to pulse generator 18. As a result, a first pulse is then produced at the summing node 30 from the contributions of the pulse generators 18, 20, 22, 24, 26, 28 activated by these enable signals.

In sum, in this way each pulse generator 18, 20, 22, 24, 26, 28 can be activated or deactivated in each segment by the appropriate issuance of segment signals and control parameters aᵢₖ stored in the allocation table 58. The control unit 12 is preferably designed such that the control parameters aᵢₖ in the allocation table 58 can be changed through the input interface 48 of the control unit 12, which results in a very high degree of flexibility in the generation of write strategies.

The control parameters aᵢₖ may be fixed for some matrix elements and variable for other matrix elements in order to avoid senseless combinations. In this case, even for matrix elements to which no variable control parameters aᵢₖ are allocated, the switching matrix 16 has for each matrix element an AND gate with a first input, a second input, and an output, wherein the first input is supplied with a signal characterizing the allocated segment, the second input is supplied with a fixed value as a control parameter, and the output is connected to the associated switching element by a tree structure of OR gates.

An example of generation of a pulse sequence with the above-described structure is explained below with reference to FIGS. 3 through 5. FIG. 3 represents time curves of segment signals 88, 90, 92, 94, 96, 98 varying between 0 and 1 as they are provided by the pulse decoder 14. The position and duration of the high level of the segment signals 88, 90, 92, 94, 96, 98 indicates the position and duration of the relevant segment in each case. Specifically, FIG. 3 shows a space pulse segment signal 88, a first pulse segment signal 90, a last pulse segment signal 92, a multi pulse segment signal 94, a mono pulse segment signal 96, and a cool pulse segment signal 98. As is evident from FIG. 3, the mono pulse segment 96 overlaps the first pulse segment 90, the multi pulse segment 94, and the last pulse segment 92.

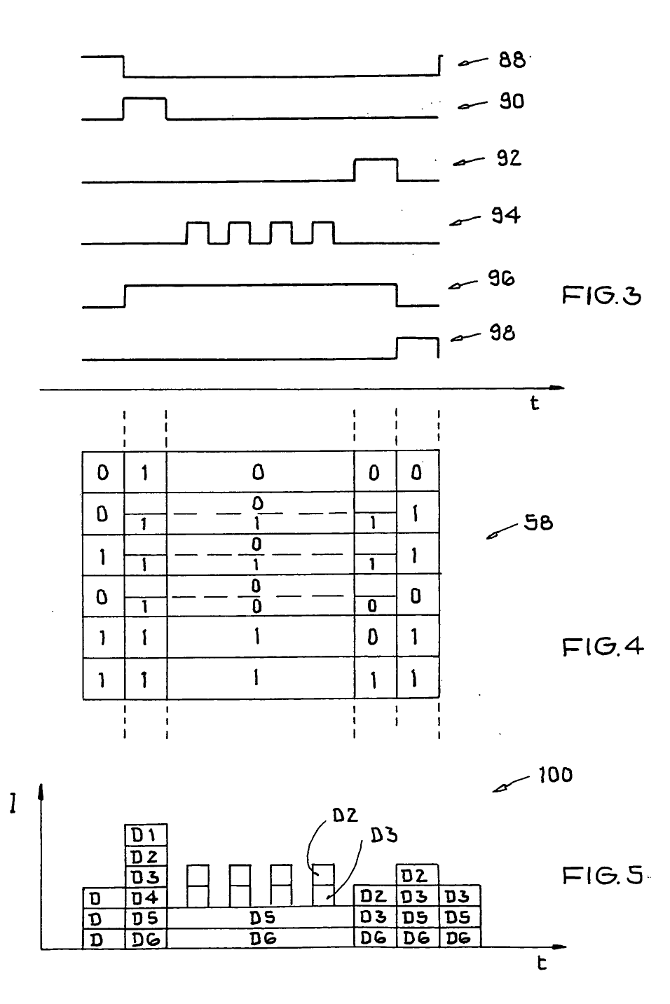

FIG. 4 shows an allocation table 58 with values for the control parameters predetermined in the relevant segments 88, 90, 92, 94, 96, 98. Here, the extension of columns of the allocation table 58 in FIG. 4 correlates in each case with the time duration of the segments 88, 90, 92, 94, 96, 98 as they result from FIG. 3. The time overlap of the mono pulse segment 96 with other segments 90, 92, 94 is expressed in the allocation table 58 by dual population of some matrix elements, wherein the top values in each case are allocated to the mono pulse segment 96. Each row of the allocation table 58 controls one pulse generator 18, 20, 22, 24, 26, 28 via the switching matrix 16 explained above such that the contributions of all the pulse generators 18, 20, 22, 24, 26, 28 to the pulse height at the summing node 30 result as a reflection of an addition of the matrix elements of a column. The multi pulses are the result of an AND operation of the matrix elements with the segment signal 94.

Consequently, for the time curves of the segment signals 88, 90, 92, 94, 96, 98 shown in FIG. 3, in conjunction with the population of the allocation table 58 shown in FIG. 4, the result is the pulse sequence 100 shown in simplified form in FIG. 5. In this context, Dj, where j=1, 2, . . . , 6, represents in each case a contribution of a pulse generator 18, 20, 22, 24, 26, 28 activated in the segment 88, 90, 92, 94, 96, 98. The representation is simplified in that the contributions Dj are all equal. As explained above, however, the individual contributions can all be set to separate values by means of data values.

It is a matter of course that the number of segments, respective segment signals 88, 90, 92, 94, 96, 98, and a number n of the pulse generators 18, 20, 22, 24, 26, 28 may also differ from the forms explained with reference to the drawing figures.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A driver circuit for providing a driver pulse sequence with different adjustable driver pulse heights in different time segments, the driver circuit comprising:
n pulse generators, which supply pulse height contributions to a summing node, wherein the supplying is controlled by switching elements individual to the pulse generators;
a control unit that controls at least a portion of the switching elements as a function of adjustable parameters; and
a switching matrix with matrix elements, each one of which is associated with a pair having at least one of the time segments and at least one control parameter, issues a control signal for exactly one switching element of one of the n pulse generators.

2. The driver circuit according to claim 1, further comprising an allocation table in which the control parameters of the switching matrix are stored.

3. The driver circuit according to claim 2, wherein at least some of the control parameters are variable.

4. The driver circuit according to claim 1, wherein the switching matrix has, for each matrix element, at least one AND gate with a first input, a second input, and an output connected to the associated switching element.

5. The driver circuit according to claim 4, wherein the first input of the AND gate is supplied with a signal characterizing the associated segment, and the second input of the AND gate is supplied with the variable control parameter.

6. The driver circuit according to claim 4, further comprising OR gates whose inputs are connected to outputs of at least two AND gates.

7. The driver circuit according to claim 4, wherein, even for matrix elements to which no variable control parameters are allocated, the switching matrix has for each matrix element an AND gate with a first input, a second input, and an output, wherein the first input is supplied with a signal characterizing the allocated segment, the second input is supplied with a fixed value as control parameter, and the output is connected to the associated switching element by a tree structure of OR gates.

8. The driver circuit according to claim 7, wherein the AND gates and the OR gates each have equal rise times and fall times.

9. The driver circuit according to claim 1, wherein the pulse generators are digital-to-analog converters.

10. A method for providing a driver pulse sequence, the method comprising the steps of:
supplying, by n pulse generators, pulse height contributions to a summing node;
controlling the supplying of the pulse height contributions by switching elements that are individual to the pulse generators; and
controlling at least a portion of the switching elements as a function of adjustable parameters,
wherein a switching matrix with matrix elements, each one of which is associated with a pair having at least one of the time segments and at least one control parameter, issues a control signal for exactly one switching element of one of the n pulse generators.

11. The method according to claim 10, wherein chronologically sequential segments of variable driver pulse height have at least one space segment and/or one first pulse segment and/or one last pulse segment and/or one multi pulse segment and/or one mono pulse segment and/or one cool pulse segment.

12. The method according to claim 10, wherein at least one of the control parameters acts as a pulse generator disable signal and other control parameters act as pulse generator enable signals.

13. The method according to claim 10, wherein a set mono pulse enable control parameter has precedence over a first pulse enable signal and a multi pulse enable signal.
